(19) United States
(12) Patent Application Publication
(10) Pub. No.: US 2007/0098088 A1
(43) Pub. Date: May 3, 2007

(54) EQUALIZER APPLIED IN MIMO-OFDM SYSTEM AND RELATED METHOD

(76) Inventors: Chih-Yuan Lin, I-Lan Hsien (TW); Ta-Sung Lee, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/163,816

(22) Filed: Oct. 31, 2005

(51) Int. Cl. H04K 1/10; H04B 1/10

(52) U.S. Cl. 375/260; 375/350

(57) ABSTRACT

An equalizer applied in a multiple input multiple output (MIMO) orthogonal frequency division multiplex (OFDM) system for alleviating interference among a plurality of received symbol blocks is disclosed. The equalizer includes: a matched filter for extracting a preliminary equalized signal vector from a received symbol block; a blocking device for generating a preliminary interference signal vector by attenuating a equalized signal vector from the received symbol block; a weighting device, electrically connected to the blocking device, for generating an interference signal vector by adjusting the preliminary interference signal vector; and a subtractor, electrically connected to the weighting device and the matched filter, for generating the equalized signal vector of the received symbol block according to the difference between the interference signal vector and the preliminary equalized signal vector.

### BACKGROUND

The disclosure relates to an equalizer, and more particularly to an equalizer applied in a MIMO-OFDM system.

Generally, a key feature of the multiple input multiple output (MIMO) system is respectively arranging a plurality of antennas at a transmitter and a receiver of the MIMO system. Therefore, the MIMO system is capable of transceiving data via a plurality of channels among the plurality of antennas. Take FIG. 1 as an example, FIG. 1 is a schematic diagram of a related art MIMO system 10. The related art MIMO system 10 comprises a transmitter 20 having three antennas 22, 24, 26, and a receiver 30 having two antennas 32, 34. The signals T₁, T₂, T₃ (i.e., a transmitted signal vector) radiate from the transmitter 20 pass through 3*2 channels 42, 44, 46, 48, 52, 54 then arrive at the receiver 30. Assume that the transmitter 20 attempts to transmit two data streams D1, D2 to the receiver 30. Firstly, the transmitter 20 generates each transmitted signal by integrating the data streams D1, D2 multiplied by different gain values. Next, the transmitter 20 transmits the transmitted signals T₁, T₂, T₃ via antennas 22, 24, 26, respectively. The operation of generating the transmitted signals T₁, T₂, T₃ is represented as the following equations:
T₁=D1*V_{1,1}+D2*V_{1,2} Equation (1)
T₂=D1*V_{2,1}+D2*V_{2,2} Equation (2)
T₃=D1*V_{3,1}+D2*V_{3,2} Equation (3)

In Equations (1), (2), (3), the elements of the three-dimension vector [V_{1,1}, V_{2,1}, V_{3,1}]^{T} determines the percentages of the transmitted signals T₁, T₂, T₃ corresponding to the data stream D1. As a result, the three-dimension vector [V_{1,1}, V_{2,1}, V_{3,1}]^{T} is a transmitting vector of the data stream D1. In the same manner, the elements of the three-dimension vector [V_{1,2}, V_{2,2}, V_{3,2}]^{T} determines the percentages of the transmitted signals T₁, T₂, T₃ corresponding to the data stream D2. Therefore, the three-dimension vector [V_{1,2}, V_{2,2}, V_{3,2}]^{T} is a transmitting vector of the data stream D1. In the related art, the MIMO system 10 utilizes a method of Singular Value Decomposition (SVD) to determine the transmitting vectors [V_{1,1}, V_{2,1}, V_{3,1}]^{T} and [V_{1,2}, V_{2,2}, V_{3,2}]^{T}, so as to make the data streams D1, D2 received by the receiver 30 orthogonal to each other. As a result, the receiver 30 is capable of extracting the data streams D1 and D2 from a plurality of received signals R¹ and R².

A popular application of the MIMO system is the MIMO-OFDM system. The transmitter of the MIMO-OFDM system radiates n symbols S₁(k), S₂(k), . . . , Sₙ(k) (i.e., a symbol block S(k)) via n antennas, and the receiver of the MIMO-OFDM system receives m symbol R¹(k), R²(k), . . . , R^{m}(k) (i.e., a received symbol block R(k)) via m antennas. According to the related art, each symbol of one symbol block comprises a cyclic prefix for alleviating the interference among a plurality of symbol blocks. The cyclic prefix is actually a copy of the last portion of the symbol appended to the front of the symbol during the guard interval. Since the multipath fading causes tones and delayed replicas of tones to arrive at the receiver with some delay spread (i.e., ISI), the cyclic prefix is utilized to allow the tones to be realigned at the receiver. Thus the tones regain orthogonal to each other with the cyclic prefix. As the phenomenon of ISI grows worse, a longer cyclic prefix is required. Because of increasing the cyclic prefix, the channel capacity is reduced accordingly. In other words, if a high-quality equalizer is adopted in the receiver of the MIMO system to alleviate the ISI, the length of the cyclic prefix can be shortened thereby increasing the channel capacity.

### SUMMARY

An equalizer applied in a MIMO-OFDM system for alleviating interference among a plurality of received symbol blocks is disclosed. The equalizer comprises: a matched filter for extracting a preliminary desired signal vector from a received symbol block; a blocking device for generating a preliminary interference signal vector by removing a desired signal vector from the received symbol block; a weighting device, electrically connected to the blocking device, for generating an interference signal vector by adjusting the preliminary interference signal vector; and a subtractor, electrically connected to the weighting device and the matched filter, for generating an equalized signal vector of the received symbol block according to the difference between the interference signal vector and the preliminary desired signal vector.

An equalizing method applied in a MIMO-OFDM system for alleviating interference among a plurality of received symbol blocks is disclosed. The equalizing method comprises: extracting a preliminary desired signal vector from a received symbol block; generating a preliminary interference signal vector by removing a desired signal vector from the received symbol block; generating an interference signal vector by adjusting the preliminary interference signal vector; and generating an equalized signal vector of the received symbol block according to the difference between the interference signal vector and the preliminary desired signal vector.

### BRIEF DESCRIPTION OF THE DRAWINGS

FIG. 1 is a schematic diagram of a MIMO system of the related art.

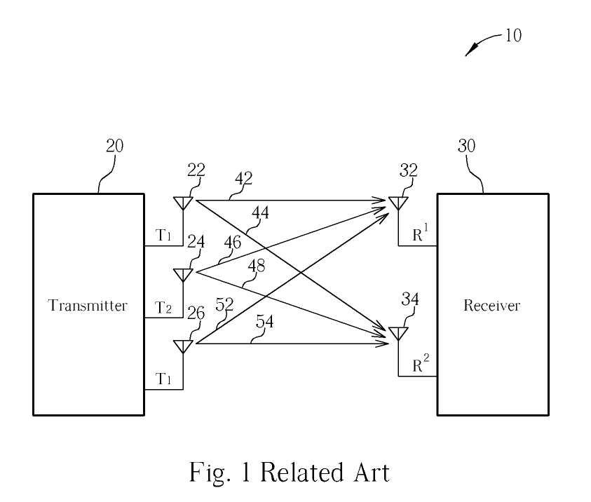

FIG. 2 is a schematic diagram of an embodiment of the equalizer applied in a receiver of the MIMO-OFDM system according to the first embodiment.

FIG. 3 is a schematic diagram of an embodiment of the equalizer applied in a receiver of the MIMO-OFDM system according to the second embodiment.

### DETAILED DESCRIPTION

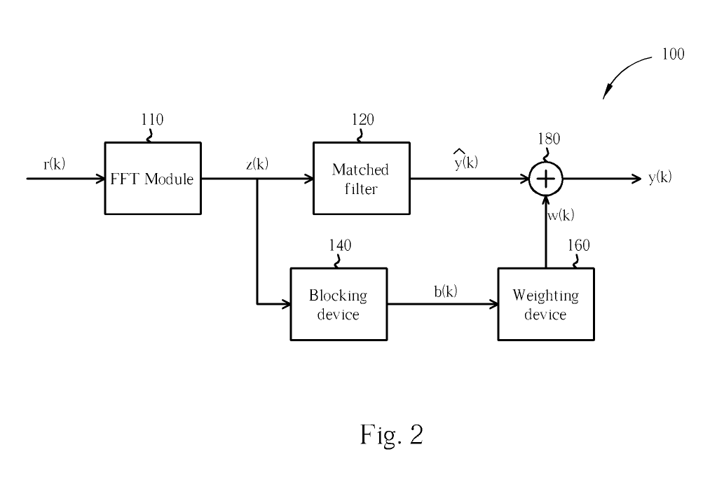

Please refer to FIG. 2. FIG. 2 is a schematic diagram of an embodiment of the equalizer 100 applied in a receiver of the MIMO-OFDM system according to the first embodiment. In the present embodiment, the equalizer 100 is Generalized Sidelobe Canceller (GSC)-based equalizer. As shown in FIG. 2, the equalizer 100 comprises a Fourier transform module 110, a matched filter 120, a blocking device 140, a weighting device 160, and a subtractor 180. Firstly, the Fourier transform module 110 generates a signal vector z(k) equal to the Fourier transform of the received symbol block r(k). The mathematical module of the received symbol block r(k) and signal vector z(k) are expressed as Equations (4) and (5).

$$r ( k ) = {[ \begin{matrix}{r}^{( 1 )} ( k ) & {r}^{( 2 )} ( k ) & … & {r}^{( M )} ( k )\end{matrix} ]}^{T} , \\ where \\ \begin{matrix}{r}^{( m )} ( k ) = {\sum }_{n = 1}^{N} {H}_{0}^{( m , n )} {F}^{- 1} {s}_{n} ( k ) + {\sum }_{n = 1}^{N} {H}_{1}^{( m , n )} {F}^{- 1} {s}_{n} ( k - 1 ) + {v}^{( m )} ( k ) \\ = {\sum }_{n = 1}^{N} {H}^{( m , n )} {F}^{- 1} {s}_{n} ( k ) + {\sum }_{n = 1}^{N} {H}_{1}^{( m , n )} {F}^{- 1} {s}_{n} ( k - 1 ) + \\ {\sum }_{n = 1}^{N} {H}_{2}^{( m , n )} {F}^{- 1} {s}_{n} ( k ) + {v}^{( m )} ( k )\end{matrix} \qquad Equation ( 4 )$$

In Equation (4), M denotes the number of receiving antennas, N denotes the number of transmitting antennas, F⁻¹ denotes a Q×Q IFFT matrix, where Q denotes the number of subcarriers, sₙ denotes the transmitted signal corresponding to the n-th antenna placed on the transmitter, r^{(m)} denotes the received symbol of the m-th transmitting antenna, v^{(m)} denotes the channel noise at the m-th receiving antenna, and H₀^{(m,n)}, H₁, and H₂ are respectively defined as:

$${H}^{( m , n )} = [ \begin{matrix}{h}^{( m , n )} ( 0 ) & 0 & {h}^{( m , n )} ( L ) & … & {h}^{( m , n )} ( 1 ) \\ ⋮ & {h}^{( m , n )} ( 0 ) & 0 & … & ⋮ \\ {h}^{( m , n )} ( L ) & … & ⋰ & … & ⋮ \\ ⋮ & ⋰ & … & ⋰ & 0 \\ 0 & … & {h}^{( m )} ( L ) & … & {h}^{( m )} ( 0 )\end{matrix} ] , \\ {H}_{1}^{( m , n )} = [ \begin{matrix}0 & … & {h}^{( m , n )} ( L ) & … & {h}^{( m , n )} ( G + 1 ) \\ ⋮ & ⋰ & 0 & ⋰ & ⋮ \\ 0 & … & ⋰ & … & {h}^{( m , n )} ( L ) \\ ⋮ & ⋮ & ⋮ & ⋰ & ⋮ \\ 0 & … & 0 & … & {h}^{( m )} ( 0 )\end{matrix} ] , \\ and$$

$${H}_{2}^{( m , n )} = [ \begin{matrix}0 & … & {h}^{( m , n )} ( L ) & … & {h}^{( m , n )} ( G + 1 ) & 0 \\ ⋮ & ⋰ & ⋰ & ⋮ & ⋮ & ⋰ \\ 0 & … & … & … & {h}^{( m , n )} ( L ) & ⋰ \\ ⋮ & ⋮ & ⋮ & ⋮ & ⋮ & ⋰ \\ 0 & … & … & 0 & 0 & 0\end{matrix} ] ,$$

where h^{(m,n)} denotes the channel impulse response between the m-th receiving antenna and n-th transmitting antenna with order L, and G denotes the length of the cyclic prefix appended in front of a symbol. In Equation (4), the fact that H₀=H+H₂ is used. It is noted that H₁ and H₂ respectively represent the effects of inter-symbol interference (ISI) and Inter-Carrier Interference (ICI). The frequency-domain counterpart of r(k) can be immediately obtained as

$$z ( k ) = {[ \begin{matrix}{z}^{( 1 ) T} ( k ) & {z}^{( 2 ) T} ( k ) & … & {z}^{( M ) T} ( k )\end{matrix} ]}^{T} , \\ where \\ \begin{matrix}{z}^{( m )} ( k ) = {Fr}^{( m )} ( k ) \\ = {\sum }_{n = 1}^{N} {FH}_{0}^{( m , n )} {F}^{- 1} {s}_{n} ( k ) + \\ {\sum }_{n = 1}^{N} {FH}_{1}^{( m , n )} {F}^{- 1} {s}_{n} ( k - 1 ) + {Fv}^{( m )} ( k ) \\ = {\sum }_{n = 1}^{N} {FH}^{( m , n )} {F}^{- 1} {s}_{n} ( k ) + \\ {\sum }_{n = 1}^{N} {FH}_{1}^{( m , n )} {F}^{- 1} {s}_{n} ( k - 1 ) - \\ {\sum }_{n = 1}^{N} {FH}_{2}^{( m , n )} {F}^{- 1} {s}_{n} ( k ) + {Fv}^{( m )} ( k ) \\ = {\sum }_{n = 1}^{N} {D}^{( m , n )} {s}_{n} ( k ) + \\ {\sum }_{n = 1}^{N} {FH}_{1}^{( m , n )} {F}^{- 1} {s}_{n} ( k - 1 ) - \\ {{\sum }_{n - 1}}^{N} {FH}_{2}^{( m , n )} {F}^{- 1} {s}_{n} ( k ) + {Fv}^{( m )} ( k ) ,\end{matrix} \\ where \\ {D}^{( m , n )} = {FH}^{( m , n )} {F}^{- 1} \qquad Equation ( 5 )$$

In Equation (5), F denotes a Q×Q FFT matrix, and D^{(m,n)} is a Q×Q signal signature matrix. The signal vector z(k) also can be expressed as:

$$\begin{matrix}z ( k ) = {\sum }_{n = 1}^{N} [ \begin{matrix}{D}^{( 1 , n )} {s}_{n} ( k ) \\ ⋮ \\ {D}^{( M , n )} {s}_{n} ( k )\end{matrix} ] + \\ {\sum }_{n = 1}^{N} [ \begin{matrix}{FH}_{1}^{( 1 , n )} {F}^{- 1} {s}_{n} ( k - 1 ) \\ ⋮ \\ {FH}_{1}^{( M , n )} {F}^{- 1} {s}_{n} ( k - 1 )\end{matrix} ] - \\ {\sum }_{n = 1}^{ N} [ \begin{matrix}{FH}_{ 2}^{( 1 , n )} {F}^{- 1} {s}_{n} ( k ) \\ ⋮ \\ {FH}_{ 2}^{( M , n )} {F}^{- 1} {s}_{n} ( k )\end{matrix} ] + n ( k ) \\ = Ds ( k ) + {F}_{M} {H}_{1} {F}_{N}^{- 1} s ( k - 1 ) - \\ {F}_{M} {H}_{2} {F}_{N}^{- 1} s ( k ) + n ( k ) \\ = Ds ( k ) + {H}_{ISI , 1} s ( k - 1 ) - {H}_{ISI , 2} s ( k ) + n ( k ) ,\end{matrix} \\ where \\ {H}_{i} = [ \begin{matrix}{H}_{i}^{( 1 , 1 )} & … & {H}_{i}^{( 1 , N )} \\ ⋮ & ⋰ & ⋮ \\ {H}_{i}^{( M , 1 )} & … & {H}_{i}^{( M , N )}\end{matrix} ] , \\ 1 \leq i \leq 2 \qquad Equation ( 6 )$$

It should be noted that F_{M}=I_{M} [symbol] F with \textcircled{×} being the Kronecker product and Iᵢ being the i×i identity matrix and F_{N}=I_{N} [symbol] F. As can be seen from the Equations (4) and (6), the value L increases as the phenomenon of ISI grows worse. Since the receiver of the MIMO-OFDM system adopts the equalizer 100 to prevent the ISI, it is not necessary to ensure the length of the appended cyclic prefix is longer than the channel length (i.e., G>L). If the equalizer 100 is adopted, it is not even necessary to append a cyclic prefix in the guard interval.

The matched filter 120 extracts a preliminary desired signal vector ŷ(k) from the signal vector z(k) with a matrix D. The matrix D is determined for alleviating the effect of multipath fading suffered by the received symbol blocks. In other words, the matched filter 120 is designed for filtering a desired signal vector very similar to the transmitted signal vector s(k). The operation of the matched filter 120 is represented in the following equation:

$$\begin{matrix}\hat{y} ( k ) = {D}^{H} \cdot z ( k ) \\ = {D}^{H} Ds ( k ) + {D}^{H} {H}_{ISI , 1} s ( k - 1 ) - \\ {D}^{H} {H}_{ISI , 2} s ( k ) + {D}^{H} n ( k )\end{matrix} \qquad Equation ( 7 )$$

In Equation (7), D denotes an MQ×NQ matrix. Since the operation of the matched filter 120 for determining the matrix D is well known, the detailed description is omitted for the sake of brevity. Next, the blocking device 140 extracts a preliminary interference signal vector b(k) by attenuating the desired signal vector from the signal vector z(k). The operation of the blocking device 140 is shown in the following equation:

$$\begin{matrix}b ( k ) = {B}^{H} \cdot z ( k ) \\ = {B}^{H} Ds ( k ) + {B}^{H} {H}_{ISI , 1} s ( k - 1 ) - \\ {B}^{H} {H}_{ISI , 2} s ( k ) + {B}^{H} n ( k )\end{matrix} \qquad Equation ( 8 )$$

Since B is an MQ×(M−N)Q matrix, the dimension of the preliminary interference signal vector is (M−N)Q. It should be noted that the columns of the matrix B are selected from a plurality of bases of the null space of the matrix D, thereby the desired signal vector of the received symbol block r(k) is theoretically filtered off. Next, the weighting device 160 generates an interference signal vector w(k) as shown in the following equation:

$$\begin{matrix}w ( k ) = {U}^{H} \cdot b ( k ) \\ = {U}^{H} {B}^{H} Ds ( k ) + {U}^{H} {B}^{H} {H}_{ISI , 1} s ( k - 1 ) - \\ {U}^{H} {B}^{H} {H}_{ISI , 2} s ( k ) + {U}^{H} {B}^{H} n ( k )\end{matrix} \qquad Equation ( 9 )$$

The weighting device 160 determines the matrix U to minimizing the ISI-plus-noise power outputted form the subtractor 180. The expected value of the ISI-plus-noise power outputted form the subtractor 180 can be expressed as the following equation:
E{∥i(k)−U^{H}B^{H}z(k)∥²}, where
i(k)=D^{H}(H_{ISI,1}s(k)−H_{ISI,2}s(k−1))+D^{H}n(k) Equation (10)
For minimizing the ISI-plus-noise power, the matrix U is determined to be (B^{H}RᵢₙB)⁻¹B^{H}RᵢₙD, in which Rᵢₙ=H_{ISI,1}H_{ISI,1}^{H}+H_{ISI,2}H_{ISI,2}^{H}+Rₙ and Rₙ is the correlation matrix of channel noise n(k), according to the Equation (10). Finally, the subtractor 180 generates the equalized signal vector y(k) according to the difference between the interference signal vector w(k) and the preliminary desired signal vector ŷ(t).

It should be noted that the major computational complexity of the equalizer 100 involves the operation of calculating the inversion of (M−N)Q×(M−N)Q matrix. That is, the operation of the weighting device 160 for calculating the inversion of (M−N)Q×(M−N)Q matrix (B^{H}RᵢₙB) to determines the matrix U. Therefore, if the operation of computing the matrix U is simplified, the computational complexity of the equalizer 100 decreases.

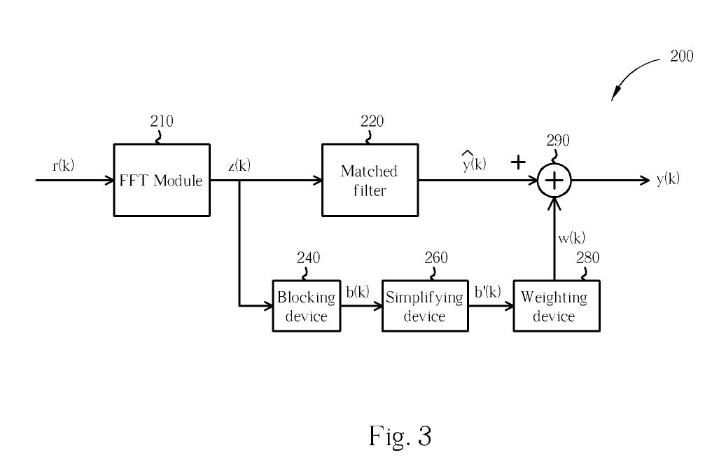

A second embodiment is disclosed to decrease the computational complexity. Please refer to FIG. 3. FIG. 3 is a schematic diagram of an embodiment of the equalizer 200 applied in a receiver of the MIMO-OFDM system according to the second embodiment. The equalizer 200 comprises a Fourier transform module 210, a matched filter 220, a blocking device 240, a simplifying device 260, a weighting device 280, and a subtractor 290. The operations and architectures of the Fourier transform module 210, the matched filter 220, the blocking device 240, and the subtractor 290 are the same with the operations and architectures of the components having the same names shown in the FIG. 2. The simplifying device 260 utilizes a matrix T to reduce the dimension of the preliminary interference signal vector b(k). The operation of the simplifying device 260 is represented as the following equation:
b′(k)=T^{H}·b(k), where T=basis of column space of B^{H}H_{ISI,1} Equation (11)

Since T is an (M−N)Q×N(L−G) matrix and the dimension of the preliminary interference signal vector b(k) is (M−N)Q×1, the dimension of the simplified preliminary interference signal vector b′(k) is N(L−G)×1. According to the specification of the OFDM system, the value Q is much greater than the values M, N, L, G. As a result, the dimension of the simplified preliminary interference signal vector b′(k) is less than the dimension of the preliminary interference signal vector b(k). Next, the weighting device 280 generates the interference signal vector w(k) as the following equation:
w(k)=U^{H}b′(k), where U=(T^{H}B^{H}RᵢₙBT)⁻¹T^{H}B^{H}RᵢₙD Equation (12)

According to the Equation (12), the size of the matrix (T^{H}B^{H}RᵢₙB^{T}) is N(L−G)×N(L−G) less than (M−N)Q×(M−N)Q. Therefore, the operation of calculating an inversion of a matrix is simplified, and the computational complexity of the weighting device 280 is reduced accordingly.

Please note that each component shown in FIG. 2 and FIG. 3 may be a computing circuit or a program module. Compared with the related art, the GSC-based equalizer is capable of alleviating the ISI and ICI. As a result, the length of the cyclic prefix of each symbol can be shortened thereby increasing the channel capacity. In addition, since the simplifying device is utilized in the GSC-based equalizer, the computational complexity of the GSC-based equalizer can be reduced.

What is claimed is:

1. An equalizer applied in a multiple input multiple output (MIMO) orthogonal frequency division multiplex (OFDM) system for alleviating interference among a plurality of received symbol blocks, the equalizer comprising:
a matched filter for extracting a preliminary equalized signal vector from a received symbol block;
a blocking device for generating a preliminary interference signal vector from the received symbol block;
a weighting device, electrically connected to the blocking device, for generating an interference signal vector by adjusting the preliminary interference signal vector; and
a subtractor, electrically connected to the weighting device and the matched filter, for generating a equalized signal vector of the received symbol block according to the difference between the interference signal vector and the preliminary equalized signal vector.

2. The equalizer of claim 1, wherein a received symbol block comprising a plurality of symbol corresponding to a plurality of antennas of a receiver of the MIMO-OFDM system, and each symbol in one received symbol block has no cyclic prefix.

3. The equalizer of claim 1, wherein the matched filter computes the product of the received symbol block and a matrix D^{H} to generate the preliminary equalized signal vector, the blocking device computes the product of the received symbol block and a matrix B^{H} to generate the preliminary interference signal vector, the matrix D^{H} is generated from a Hermitian operation of a matrix D, the matrix B^{H} is generated from a Hermitian operation of a matrix B, and a plurality of columns of the matrix B are chosen from a plurality of bases of the null space of the matrix D.

4. The equalizer of claim 3, wherein the weighting device generates the interference signal vector by computing the product of the preliminary interference signal vector and a Hermitian operation of a weight matrix U, and the weight matrix U is determined according to the matrix D and the matrix B.

5. The equalizer of claim 4, wherein the matrix U is (B·Rᵢₙ·B)⁻¹·B^{H}·Rᵢₙ·D, where Rᵢₙ corresponds to the sum of the correlations of H_{ISI,1}, H_{ISI,2}, and a channel noise n(k)

6. The equalizer of claim 1, further comprises:
a simplifying device, electrically connected between the blocking device and the weighting device, for multiplying the preliminary interference signal vector and a transformation matrix T to simplify the dimension of the preliminary interference signal vector, thereby reducing the computational load of the weighting device.

7. The equalizer of claim 6, wherein a plurality of columns of the transformation matrix T are chosen from a plurality of bases of a product of matrices B^{H} and H_{ISI,1}, where the H_{ISI,1} is F_{M}H₁F_{N}⁻¹, F_{M} and F_{N}⁻¹ are respectively the FFT and IFFT modules, and H₁ denotes a channel matrix related to the ISI component.

8. A equalizing method applied to a multiple input multiple output (MIMO) orthogonal frequency division multiplex (OFDM) system for alleviating interference among a plurality of received symbol blocks, the equalizing method comprising:
extracting a preliminary equalized signal vector from a received symbol block;
generating a preliminary interference signal vector from the received symbol block;
generating an interference signal vector by adjusting the preliminary interference signal vector; and
generating a equalized signal vector of the received symbol block according to the difference between the interference signal vector and the preliminary equalized signal vector.

9. The equalizing method of claim 8, wherein a received symbol block comprising a plurality of symbols corresponding to a plurality of antennas of a receiver of the MIMO-OFDM system, and each symbol in one received symbol block has no cyclic prefix.

10. The equalizing method of claim 8, wherein the step of generating the preliminary equalized signal vector comprises:
computing the product of the received symbol block and a matrix D^{H} to generate the preliminary equalized signal vector; and
the step of generating the preliminary interference signal vector comprises:
computing the product of the received symbol block and a matrix B^{H} to generate the preliminary interference signal vector, where the matrix D^{H} is generated from a Hermitian operation of a matrix D, the matrix B^{H} is generated from a Hermitian operation of a matrix B, and a plurality of columns of the matrix B are chosen from a plurality of bases of the null space of the matrix D.

11. The equalizing method of claim 10, wherein the step of generating the interference signal vector comprises:
computing the product of the preliminary interference signal vector and a Hermitian operation of a weight matrix U, where the weight matrix U is determined according to the matrix D and the matrix B.

12. The equalizing method of claim 11, wherein the matrix U is (B·Rᵢₙ·B)⁻¹·B^{H}·Rᵢₙ·D, and Rᵢₙ corresponds to a sum of a correlation of H_{ISI,1}, H_{ISI,2} and a channel noise n(k)

13. The equalizing method of claim 8, further comprises:
multiplying the preliminary interference signal vector and a transformation matrix T to simplify the dimension of the preliminary interference signal vector, thereby reducing the computational complexity of the step of generating the interference signal vector.

14. The equalizing method of claim 13, wherein a plurality of columns of the transformation matrix T are chosen from a plurality of bases of a product of matrices B^{H} and H_{ISI,1}, where the H_{ISI,1} is F_{M}H₁F_{N}⁻¹, F_{M} and F_{N}⁻¹ are respectively the FFT and IFFT modules, and H₁ denotes a channel matrix related to the ISI component.
